(19) United States
(12) Patent Application Publication
(10) Pub. No.: US 2026/0369032 A1
(43) Pub. Date: Nov. 19, 2026

(54) SETTING APPARATUS

(71) Applicant: NEC Corporation, Tokyo (JP)

(72) Inventor: Soma SHIRAISHI, Tokyo (JP)

(73) Assignee: NEC Corporation, Tokyo (JP)

(21) Appl. No.: 19/154,439

(22) PCT Filed: Feb. 16, 2023
(86) PCT No.: PCT/JP2023/005521

§ 371 Date: Aug. 7, 2025

(51) Int. Cl. G06V 10/762; G06Q 10/087; G06V 10/40; G06V 10/74; G06V 10/764; G06V 20/52

(52) U.S. Cl. CPC G06V 10/762; G06Q 10/08724; G06V 10/40; G06V 10/761; G06V 10/764; G06V 20/52

(57) ABSTRACT

A setting apparatus includes: a clustering unit that performs clustering, which is a process of classifying a plurality of objects, based on the feature values of the objects extracted from image data including the objects in a subject and the positions of the objects; and a setting unit that sets a target frame indicating a range to perform stockout detection, based on the result of clustering by the clustering unit and the image data.

### TECHNICAL FIELD

The present invention relates to a setting apparatus, a setting method, and a recording medium.

### BACKGROUND ART

There is a known technique used for detecting stockout in a product rack and the like.

For example, Patent Literature 1 describes a product monitoring device that monitors the arrangement status of products based on a video obtained by capturing an arrangement area in a store. For example, according to Patent Literature 1, a state monitoring area is set on the video of the arrangement area in response to an input operation by a user performed using an input device. Then, the product monitoring device determines the arrangement state of products for each state monitoring area. Moreover, Patent Literature 1 discloses use of a product occupancy ratio, which is a ratio occupied by products in the video of the arrangement area, as a numerical value representing the arrangement state.

Further, a related technique is, for example, Patent Literature 2. Patent Literature 2 describes an item recognition device that extracts an item region of an item from an image, extracts feature information indicating a feature of the item region from each object region, and identifies an item of the same kind based on the feature information. Moreover, Patent Literature 2 discloses as an example that it is identified whether or not to be a region where the same kind is present by determining whether or not the feature information matches for each adjacent item region.

### CITATION LIST

### Patent Literature

Patent Literature 1: Japanese Unexamined Patent Application Publication No. JP-A 2016-057952

Patent Literature 2: Japanese Unexamined Patent Application Publication No. JP-A 2020-068006

### SUMMARY OF INVENTION

### Technical Problem

In the case of the technique described in Patent Literature 1, there is a need to manually set a range to monitor the state of products. Therefore, there is a problem such as the setting cost. Moreover, in the technique described in Patent Literature 2, an object region in which the same kind is present is identified simply. Therefore, even if the technique described in Patent Literature 2 is used, it is difficult to set an appropriate range for product monitoring, and it is difficult to solve the above problem. For example, as described above, there is a problem that it is difficult to accurately set an appropriate range for product monitoring.

Accordingly, an object of the present invention is to provide a setting apparatus, a setting method and a program that can solve the abovementioned problem.

### Solution to Problem

In order to achieve the object, a setting apparatus as an aspect of the present disclosure includes: a clustering unit configured to perform clustering, which is a process of classifying a plurality of objects, based on feature values of the objects extracted from image data including the objects in a subject and positions of the objects; and a setting unit configured to set a target frame indicating a range to perform stockout detection, based on a result of the clustering by the clustering unit and the image data.

Further, a setting method as another aspect of the present disclosure includes: performing clustering, which is a process of classifying a plurality of objects, based on feature values of the objects extracted from image data including the objects in a subject and positions of the objects; and setting a target frame indicating a range to perform stockout detection, based on a result of the clustering and the image data.

Further, a recording medium as an aspect of the present invention is a non-transitory computer-readable recording medium where a program is recorded, and the program includes instructions for causing an information processing apparatus to execute processes to: perform clustering, which is a process of classifying a plurality of objects, based on feature values of the objects extracted from image data including the objects in a subject and positions of the objects; and set a target frame indicating a range to perform stockout detection, based on a result of the clustering and the image data.

### Advantageous Effects of Invention

According to the configurations as described above, it is possible to solve the problem as described above.

### BRIEF DESCRIPTION OF THE DRAWINGS

FIG. 1 is a diagram for describing the overview of a detection system in a first example embodiment of the present invention.

FIG. 2 is a diagram for describing the overview of the detection system.

FIG. 3 is a diagram showing an example of a configuration of the detection system.

FIG. 4 is a block diagram showing an example of a configuration of a detection apparatus.

FIG. 5 is a diagram showing an example of an object detection process.

FIG. 6 is a diagram for describing an example of a clustering process.

FIG. 7 is a diagram for describing an example of the clustering process.

FIG. 8 is a diagram for describing an example of the clustering process.

FIG. 9 is a diagram for describing an example of the clustering process.

FIG. 10 is a diagram for describing an example of the clustering process.

FIG. 11 is a diagram for describing an example of a target frame setting process.

FIG. 12 is a diagram for describing an example of the target frame setting process.

FIG. 13 is a diagram for describing an example of the target frame setting process.

FIG. 14 is a diagram showing an example of output by the detection apparatus.

FIG. 15 is a flowchart showing an example of operation of the detection apparatus at the time of target frame setting.

FIG. 16 is a flowchart showing an example of operation of the detection apparatus when performing stockout detection.

FIG. 17 is a block diagram showing another example of the configuration of the detection apparatus.

FIG. 18 is a diagram showing an example of a hardware configuration of a setting apparatus in a second example embodiment of the present disclosure.

FIG. 19 is a block diagram showing an example of a configuration of the setting apparatus.

### DESCRIPTION OF EXAMPLE EMBODIMENTS

### First Example Embodiment

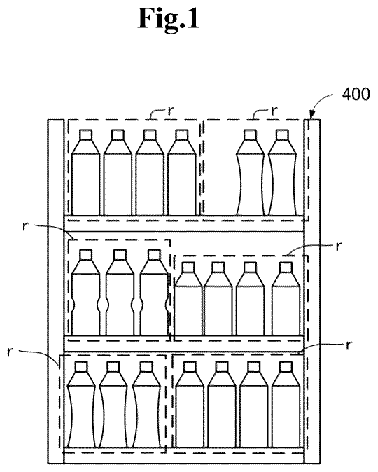

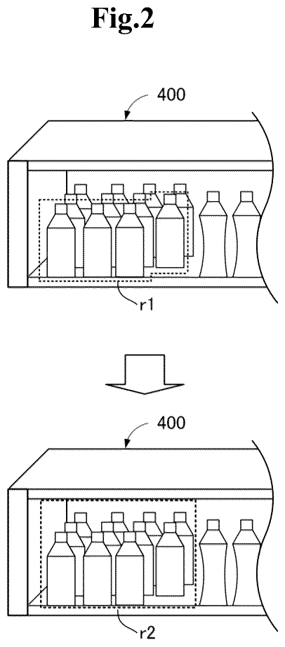

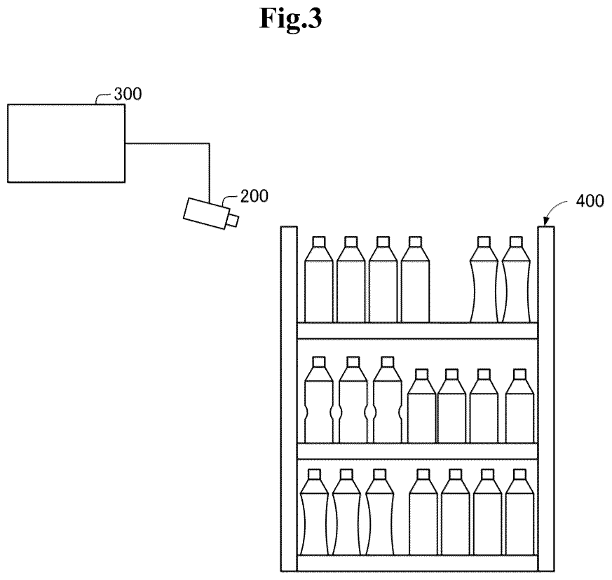

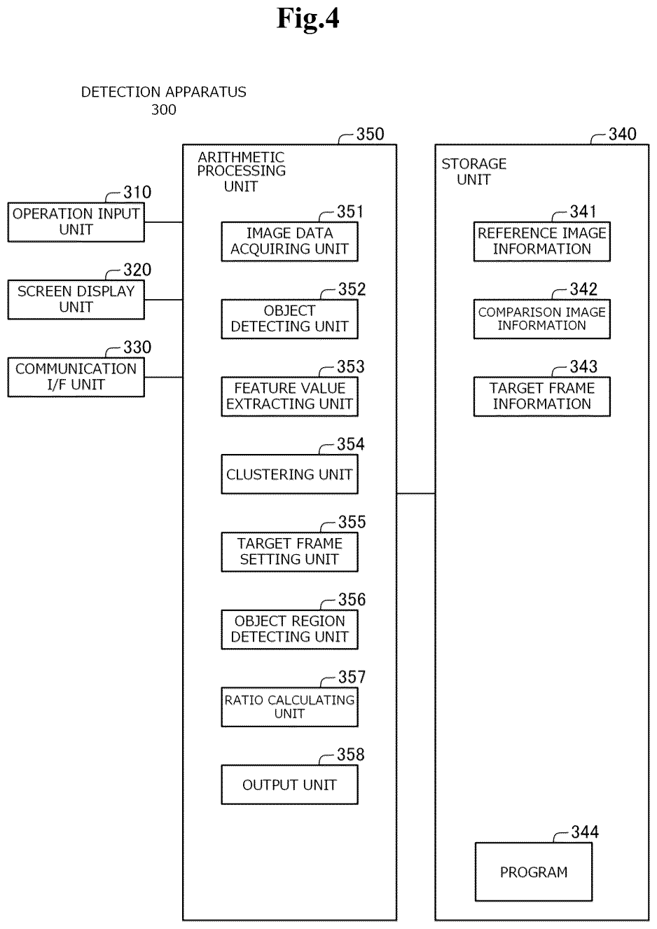

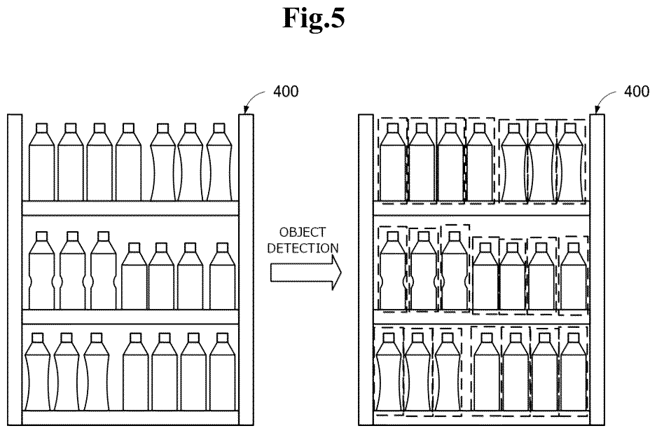

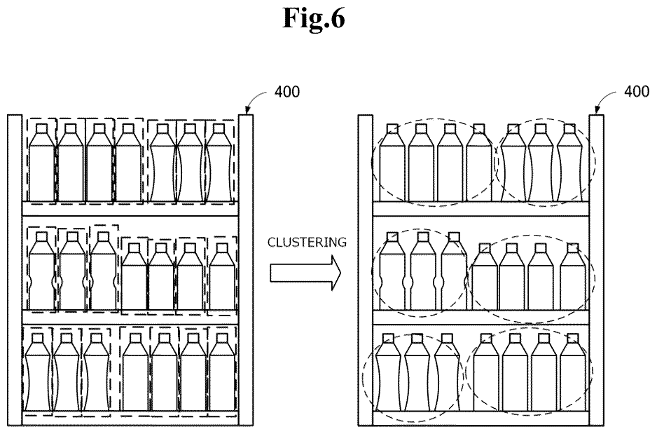

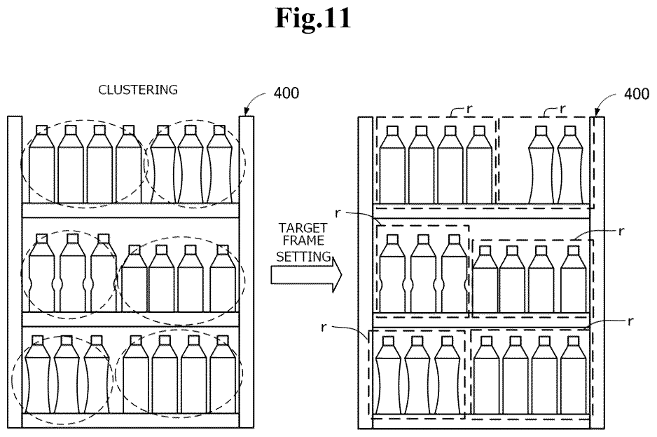

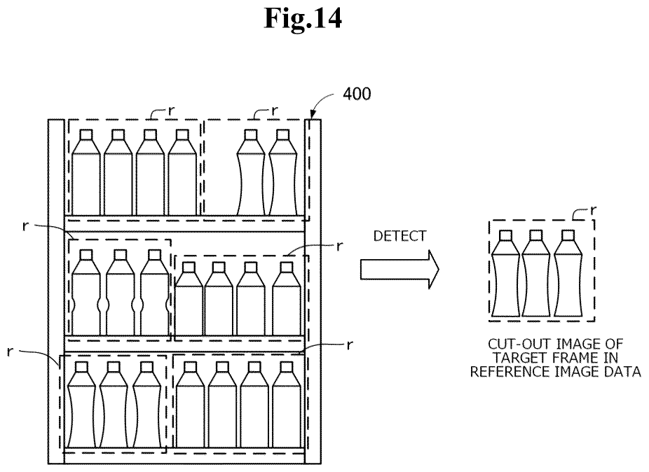

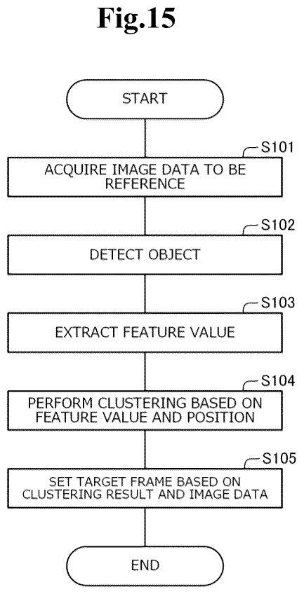

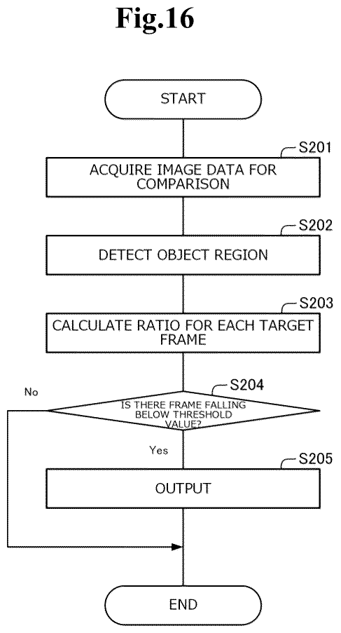

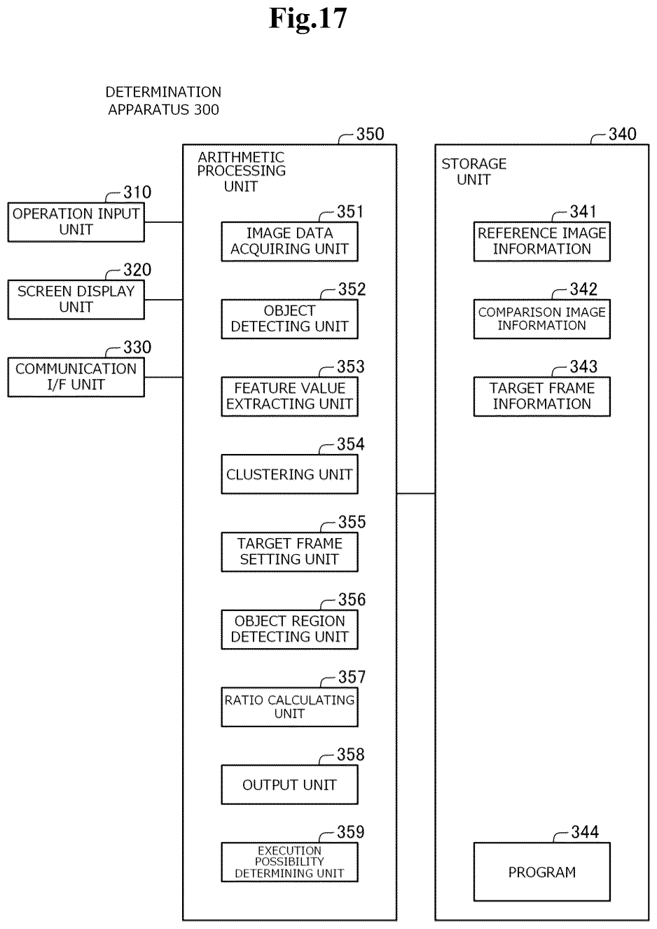

A first example embodiment of the present invention will be described with reference to FIGS. 1 to 17. FIGS. 1 and 2 are diagrams for describing the overview of a detection system 100. FIG. 3 is a diagram showing an example of a configuration of the detection system 100. FIG. 4 is a block diagram showing an example of a configuration of a detection apparatus 300. FIG. 5 is a diagram showing an example of an object detection process. FIGS. 6 to 10 are diagrams for describing an example of a clustering process. FIGS. 11 to 13 are diagrams for describing an example of a target frame setting process. FIG. 14 is a diagram showing an example of output by the detection apparatus 300. FIG. 15 is a flowchart showing an example of operation of the detection apparatus 300 at the time of target frame setting. FIG. 16 is a flowchart showing an example of operation of the detection apparatus 300 when performing stockout detection. FIG. 17 is a block diagram showing another example of the configuration of the detection apparatus.

In the first example embodiment of the present disclosure, the detection system 100 that performs stockout detection using image data with a product rack 400 including a plurality of products as a subject will be described. As shown in FIG. 1, in the detection system 100 of the present disclosure, a target frame r to be subjected to stockout detection is set in advance based on the result of object detection on the image data. Moreover, upon acquiring image data for detection, the detection system 100 detects an object region that is a region where a product is present in the image data, and calculates the ratio occupied by the object region for each target frame r set in advance. Then, the detection system 100 performs stockout detection for each target frame r based on the calculated result. Thus, the detection system 100 in the present disclosure automatically sets a target frame r indicating a range to be subjected to stockout detection, and performs stockout detection for each target frame r using the preset target frame r. In other words, the detection system 100 performs stockout detection to detect based on a preset target frame r that the ratio occupied by products in the target frame r is less than a predetermined criterion.

FIG. 2 is a diagram for describing the overview of a target frame setting process in the present disclosure. For example, when setting a target frame r, the detection system 100 performs clustering based on the feature value and position of a product extracted through a predetermined process. Then, the detection system 100 sets a target frame r for performing stockout detection based on the result of clustering. At this time, the detection system 100 does not simply set the target frame r based on the result of clustering, but can set the target frame r based on the result of clustering and image data in such a manner as to include as much as possible a product that is a stockout detection target.

For example, as illustrated in FIG. 2, in the case of a situation that products are arranged in multiple rows in the product rack 400, products arranged backward are hidden by products arranged forward. Therefore, the detection system 100 cannot properly extract the feature values of the products hidden behind, and performs clustering by extracting feature values from the products located forward from which feature values can be extracted. If the target frame r is set simply based on the result of such clustering alone, the target frame r is set in such a manner as to include only some of the arranged products, like a target frame r1 illustrated in FIG. 2. As a result, when stockout detection is performed using the target frame r1, for example, stockout may be detected when one of the products in the front row is left, so that it is difficult to perform appropriate stockout detection. On the other hand, the detection system 100 in the present disclosure sets the target frame r in such a manner as to include a detection target based on the result of clustering and image data. For example, the detection system 100 sets the target frame r in accordance with the result of clustering and the results of shelf board line detection and detection of a range where an object such as a product is present based on image data. Consequently, as seen from a target frame r2 illustrated in FIG. 2, the detection system 100 can set the target frame r in such a manner as to more properly include a product to be subjected to stockout detection. This allows more appropriate stockout detection.

The present disclosure illustrates a case where a stockout detection target is any product being arranged in the product rack 400. However, the stockout detection target may not necessarily be a product. For example, the stockout detection target may be any object other than a product, such as a promotional item being arranged on a shelf.

FIG. 3 shows an example of a configuration of the entire detection system 100. Referring to FIG. 3, for example, the detection system 100 includes an image pickup device 200 and the detection apparatus 300. As illustrated in FIG. 3, the image pickup device 200 and the detection apparatus 300 are connected so as to be able to communicate with each other via a wired or wireless connection.

FIG. 3 illustrates a case where the detection system 100 includes one image pickup device 200. However, the number of image pickup devices 200 included by the detection system 100 is not limited to one. The detection system 100 may have one image pickup device 200, or may have a plurality of image pickup devices 200.

The image pickup device 200 is installed in advance at a predetermined location such as a store, and acquires image data. The image pickup device 200 can be a general device such as a monitoring camera. In the case of the present disclosure, the image pickup device 200 acquires image data with at least part of the product rack 400 where a plurality of products are arranged as a subject. In other words, the image pickup device 200 acquires image data including at least products to be a stockout detection target. Moreover, the image pickup device 200 can acquire time-series image data with different image pickup times on the same range set in advance.

In the case of the present disclosure, the image pickup device 200 can acquire image data for target frame setting. For example, the image pickup device 200 acquires image data for target frame setting in accordance with an operation by an operator on the image pickup device 200 or the detection apparatus 300, an instruction from the detection apparatus 300, and the like. The image pickup device 200 may acquire image data for target frame setting in accordance with any other trigger such as the time. Moreover, the image pickup device 200 can transmit image data for target frame setting to the detection apparatus 300 together with any information indicating that it is for target frame setting in such a manner that the detection apparatus 300 can determine as for target fame setting. Moreover, the image pickup device 200 can acquire image data for detection to be subjected to confirmation whether or not a stockout has occurred. For example, the image pickup device 200 can start acquiring image data for detection in accordance with an operation by an operator on the image pickup device 200 or the detection apparatus 300, an instruction from the detection apparatus 300, and the like. The image pickup device 200 may acquire image data for detection based on the time such as during the opening time. Moreover, the image pickup device 200 can transmit image data for detection to the detection apparatus 300 together with any information indicating that it is for detection in such a manner that the detection apparatus 300 can determine as for detection.

Meanwhile, the detection apparatus 300 is configured to perform the determination of the use of image data. In this case, the image pickup device 200 may transmit image data to the detection apparatus 300 without distinguishing between for target frame setting and for detection.

The detection apparatus 300 is an information processing apparatus that performs stockout detection using a preset target frame r. Moreover, the detection apparatus 300 can set a target frame r for stockout detection based on image data for target frame setting. In other words, the detection apparatus 300 also has a function as a setting apparatus that sets a target frame r for stockout detection.

FIG. 4 shows an example of a configuration of the detection apparatus 300. Referring to FIG. 4, the detection apparatus 300 includes, as main components, an operation input unit 310, a screen display unit 320, a communication I/F unit 330, a storage unit 340, and an arithmetic processing unit 350, for example.

FIG. 4 illustrates a case of enabling a function as the detection apparatus 300 using one information processing apparatus. However, the detection apparatus 300 may be enabled using a plurality of information processing apparatuses, such as being enabled on the cloud. For example, the detection apparatus 300 may include a setting apparatus having a configuration for target frame setting to be described later, and a detection device having a configuration for detection to be described later. Moreover, the detection apparatus 300 may not include part of the configuration illustrated above, such as not having the operation input unit 310 or the screen display unit 320, or may have a configuration other than the configuration illustrated above.

The operation input unit 310 is configured with an operation input device such as a keyboard and a mouse. The operation input unit 310 detects an operation by an operator who operates the detection apparatus 300, and outputs it to the arithmetic processing unit 350.

The screen display unit 320 is configured with a screen display device such as an LCD (liquid crystal display). The screen display unit 320 can display on a screen a variety of information stored in the storage unit 340 in accordance with an instruction from the arithmetic processing unit 350.

The communication I/F unit 330 is configured with a data communication circuit and the like. The communication I/F unit 330 performs data communication with an external device connected via a communication line.

The storage unit 340 is a storage device such as a hard disk and memory. The storage unit 340 stores processing information and a program 344 necessary for a variety of processing by the arithmetic processing unit 350. The program 344 enables various processing units by being loaded and executed by the arithmetic processing unit 350. The program 344 is loaded in advance from an external device or a recording medium via a data input/output function such as the communication I/F unit 330, and stored in the storage unit 340. Main information stored in the storage unit 340 includes, for example, reference image information 341, comparison image information 342, and target frame information 343.

The reference image information 341 includes image data for target frame setting, acquired by the image pickup device 200. The reference image information 341 may include a plurality of image data with different acquisition times. For example, the reference image information 341 is updated in accordance with acquisition of image data for target frame setting from the image pickup device 200 by an image data acquiring unit 351 to be described later.

The comparison image information 342 includes image data for detection to be subjected to confirmation whether or not a stockout has occurred, acquired by the image pickup device 200. The comparison image information 342 may include a plurality of image data with different acquisition times. For example, the comparison image information 342 is updated in accordance with acquisition of image data for detection from the image pickup device 200 by the image data acquiring unit 351 to be described later.

The target frame information 343 includes information on the position of a target frame r in image data. The target frame information 343 may include information on the respective positions of a plurality of target frames r set by a target frame setting unit 355 to be described later. For example, the target frame information 343 is updated in accordance with setting of a target frame r by a target frame setting unit 355 to be described later.

The arithmetic processing unit 350 includes an arithmetic logic unit such as a CPU (Central Processing Unit) and a peripheral circuit thereof. The arithmetic processing unit 350 loads the program 344 from the storage unit 340 and executes it, thereby making the above hardware and the program 344 cooperate and enabling various processing units. Main processing units enabled by the arithmetic processing unit 350 include, for example, an image data acquiring unit 351, an object detecting unit 352, a feature value extracting unit 353, a clustering unit 354, a target frame setting unit 355, an object region detecting unit 356, a ratio calculating unit 357, and an output unit 358.

The arithmetic processing unit 350 may have a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

The image data acquiring unit 351 acquires image data from the image pickup device 200. For example, the image data acquiring unit 351 acquires image data from the image pickup device 200 via the communication I/F unit 330 and the like.

For example, the image data acquiring unit 351 acquires image data for target frame setting from the image pickup device 200. Then, the image data acquiring unit 351 stores the acquired image data as the reference image information 341 into the storage unit 340. Moreover, the image data acquiring unit 351 acquires image data for detection from the image pickup device 200. Then, the image data acquiring unit 351 stores the acquired image data as the comparison image information 342 into the storage unit 340.

The image data acquiring unit 351 may be configured to store the image data in the storage unit 340 in accordance with the result of determining the use of the acquired image data. For example, the image data acquiring unit 351 may determine the use of the image data in accordance with the acquisition time of the image data.

The object detecting unit 352 performs an object detection process to detect a product portion in image data based on the image data for target frame setting stored in the storage unit 340 as the reference image information 341. The object detecting unit 352 may detect a product portion in image data by inputting the image data for target frame setting into a previously trained model such as a general-purpose product detector. The object detecting unit 352 may perform object detection using other known methods.

FIG. 5 shows an example of the object detection process by the object detecting unit 352. Referring to FIG. 5, for example, the object detecting unit 352 can acquire a rectangle including the detected product portion by performing the object detection process. In the case illustrated in FIG. 5, the object detecting unit 352 acquires 7 rectangles per stage of the product rack 400, a total of 21 rectangles.

The feature value extracting unit 353 extracts a feature value of a product that is an object by extracting a feature value from the rectangle detected by the object detecting unit 352. For example, the feature value extracting unit 353 extracts a feature value corresponding to the appearance of a product such as the outer shape, color and pattern of the product as the feature value of the product detected by the object detecting unit 352. The feature value extracting unit 353 may extract a feature value of a product by inputting the rectangle acquired by the object detecting unit 352 into a previously learned feature value extractor or the like. The feature value extracting unit 353 may extract a feature value using other known methods.

The acquisition of the rectangle by the object detecting unit 352 and the extraction of the feature value by the feature value extracting unit 353 may be performed in a single process. For example, the detection apparatus 300 may perform the acquisition of the rectangle and the extraction of the feature value in a single process by inputting image data into a trained model that simultaneously performs object detection and feature value extraction based on input image data.

The clustering unit 354 performs clustering based on the feature value extracted by the feature value extracting unit 353 and the position of the product from which the feature value is extracted. That is to say, the clustering unit 354 classifies products in image data into a plurality of clusters based on the feature values extracted by the feature value extracting unit 353, the positional relation of the products, and so forth. In general, in the product rack 400, products of the same type are arranged on the same shelf. Therefore, the clustering unit 354 can perform clustering for each shelf of the product rack 400. For example, FIG. 6 shows an example of clustering by the clustering unit 354. In the case illustrated in FIG. 6, the clustering unit 354 classifies each shelf into two clusters by performing clustering for each shelf of the product rack 400. The clustering unit 354 may perform clustering on a plurality of shelves together.

In the case of the present disclosure, the clustering unit 354 can perform clustering to divide into a predetermined number of clusters, such as a preset number based on a feature value, for each product arranged on the same shelf of the product rack 400. The clustering unit 354 may perform the above clustering by comparing the feature values in the same shelf and classifying products determined to be similar, for example, products with the degree of similarity such as the distance between the feature values being less than or equal to a predetermined threshold value, into the same cluster. In other words, the number of clusters for classification by the clustering unit 354 may be previously determined or may not be previously determined. In the above processing, the clustering unit 354 may be configured to perform classification according to the positional relation of products, for example, classifying products into the same cluster only when the distance between products is determined to be equal to or less than a predetermined value.

Further, the clustering unit 354 may be configured to execute at least one of the methods described below.

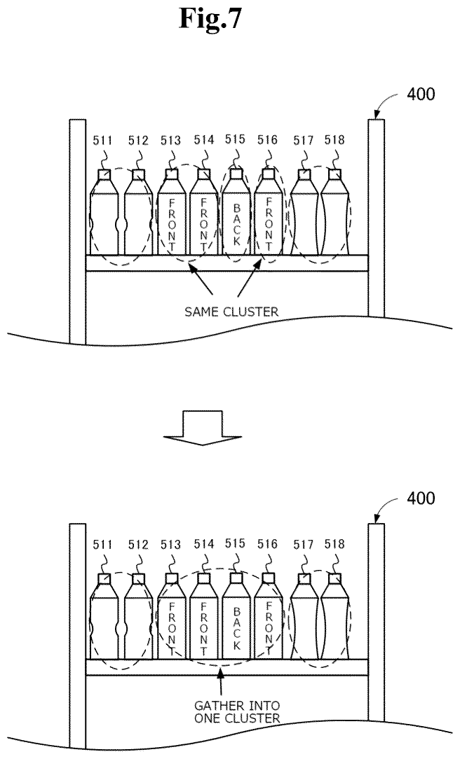

For example, the clustering unit 354 can be configured to, when products are determined to belong to the same cluster based on the feature values and the positional relation of the products, classify each product into a cluster according to the determination result. For example, as shown in FIG. 7, in a situation where any of the products is facing a different direction, the extracted feature value may be different even it is the same product. For example, in the case illustrated in FIG. 7, products 511 and 512 are the same type of products, and products 517 and 518 are the same type of products. Moreover, products 513, 514, 515 and 516 are the same type of products, but only the product 515 is arranged facing in a different direction. In such a state, the feature values extracted from the products 513, 514 and 516 differ from the feature value extracted from the product 515. As a result, the clustering unit 354 will classify the products 513, 514 and 516 and the product 515 into separate clusters. To address such a case, the clustering unit 354 can be configured to, when classifying non-adjacent products into one cluster, determine that a product arranged between the non-adjacent products belongs to the same cluster. In other words, the clustering unit 354 determines that the product 515 located between the products 514 and 516 belonging to the same cluster belongs to the same cluster as the products 514 and 516 based on the positional relation of the products. As a result, the clustering unit 354 can classify the products 513, 514, 515 and 516 into one cluster.

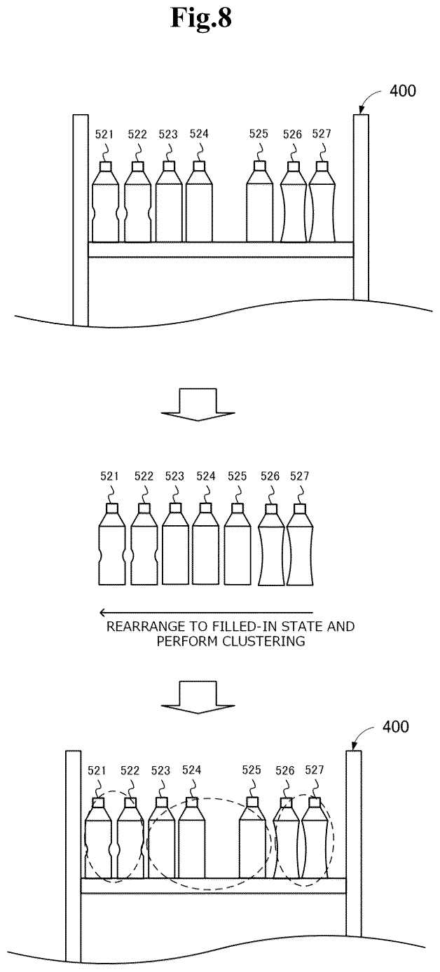

Further, when a certain condition is satisfied, such as when there is gap in products, the clustering unit 354 can perform clustering based on the positional relation of feature values by comparing adjacent feature values after rearranging from the state with a product missing to a filled-in state. For example, as shown in FIG. 8, there is a case where any of the products is missing. For example, in the case illustrated in FIG. 8, products 521, 522, 523, 524, 525, 526 and 527 are present on the same shelf, but there is a gap between the product 524 and the product 525. In such a case, the clustering unit 354 sorts the products in an arranged order such as ascending order of x-axis coordinates. Subsequently, the clustering unit 354 can compare adjacent feature values and classify products determined to be similar into the same cluster. As a result, as illustrated in FIG. 8, it is possible to classify the products into appropriate clusters even when a product is missing.

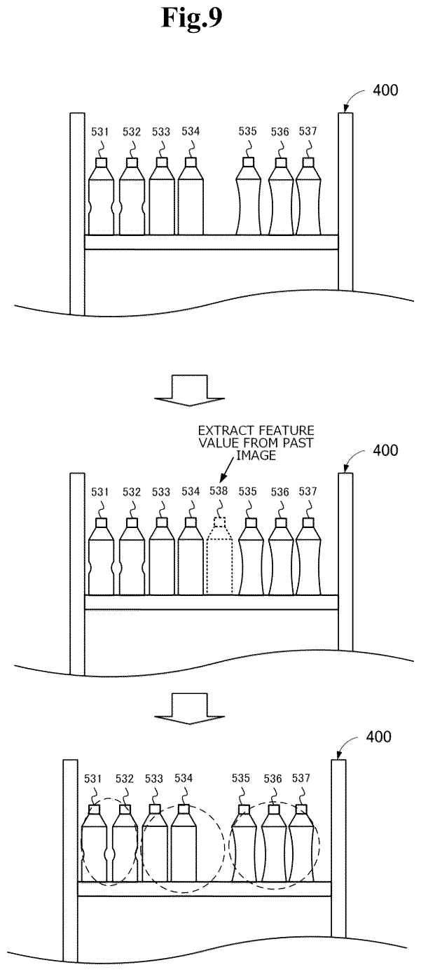

Further, the clustering unit 354 may be configured to, when there is a gap as mentioned above, perform clustering using a feature value extracted from past image data, instead of the aforementioned sorting. For example, in the case illustrated in FIG. 9, products 531, 532, 533, 534, 535, 536 and 537 are present on the same shelf, but there is a gap between the product 534 and the product 535. In such a case, the clustering unit 354 identifies a product 538, which is a product present in a location corresponding to the gap in the past image data, by referring to the reference image information 341 and the comparison image information 342. Then, the clustering unit 354 can perform clustering using the result of extraction by the feature value extracting unit 353 for the identified product 538. As a result, as illustrated in FIG. 9, even if a product is missing, it is possible to classify into an appropriate cluster. In this way, the clustering unit 354 may be configured to perform clustering using a feature value extracted from past image data when a certain condition is satisfied, such as when it is determined that a product is missing. Regarding past image data, it is preferable to use past image data that can be considered temporally close, such as using the image data captured at the time closest to the current time when a product is present in the gap. Additionally, when performing clustering using a feature value extracted from past image data, as illustrated in FIG. 9, even if there is a gap at the edge of products, it is possible to classify into an appropriate cluster without any issue.

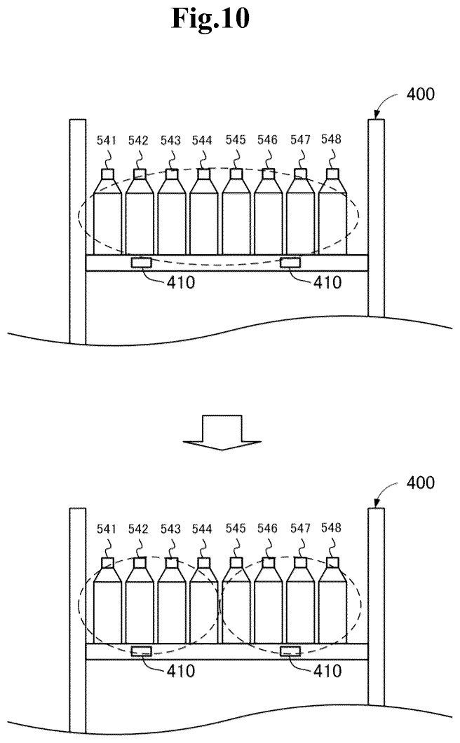

Further, the clustering unit 354 may be configured to perform classification based on the result of detection of a shelf tag 410 installed on the product rack 400. For example, as illustrated in FIG. 10, there may be a case where there is a discrepancy between the number of clusters and the number of shelf tags 410, such as a case where there are a plurality of shelf tags 410 though classified into one cluster as a result of comparison of the feature values. In such a case, the clustering unit 354 can increase or decrease the number of clusters so as to match the number of shelf tags 410. In other words, the clustering unit 354 can control the number of clusters for classifying products based on the number of shelf tags 410. For example, in the case illustrated in FIG. 10, the clustering unit 354 classifies products 541 to 548 into one cluster. On the other hand, at a lower part of the product rack 400, two shelf tags 410 are detected by any detector. Thus, in the case illustrated in FIG. 10, there is a discrepancy between the number of clusters and the number of shelf tags 410. Then, the clustering unit 354 can reclassify in such a manner that the number of clusters matches the number of shelf tags. As a result, the products 541 to 548 are classified into two clusters. For example, in the case illustrated in FIG. 10, the clustering unit 354 classifies the products 541, 542, 543 and 544 into one cluster, and classifies the products 545, 546, 547 and 548 into the other cluster.

For example, the clustering unit 354 can be configured to perform at least one of the abovementioned processes. In the case of performing clustering based on the results of comparing feature values within the same shelf, the clustering unit 354 can determine whether the feature values are similar based on the degree of similarity such as the distance between feature values and a predetermined threshold value. In this case, the predetermined threshold value to be compared with the degree of similarity may be either a predetermined fixed value or a value dynamically determined by the clustering unit 354 or the like. For example, in the case of dynamically determining the threshold value, the clustering unit 354 may set the threshold value based on the degree of similarity between adjacent products and the degree of similarity between non-adjacent products. For instance, the clustering unit 354 calculates the degree of similarity, such as the distance between feature values, for each pair of adjacent products across the entire image data. Moreover, the clustering unit 354 calculates the degree of similarity for each pair of non-adjacent products across the entire image data. Then, the clustering unit 354 can determine the threshold value according to the distribution of the calculated degrees of similarity. For example, the clustering unit 354 may determine, as the threshold value, any value between the average of degrees of similarity between adjacent products and the average of degrees of similarity between non-adjacent products items. The clustering unit 354 may dynamically determine the threshold value using methods other than the one exemplified above.

As shown in FIG. 11, the target frame setting unit 355 sets a target frame r indicating a range for stockout detection based on the result of clustering by the clustering unit 354 and the image data. For example, the target frame setting unit 355 identifies a range where products are possibly present based on the image data, and sets the target frame r in such a manner as to include the identified range. Additionally, the target frame setting unit 355 stores information indicating the position of the set target frame r in the image data as the target frame information 343 into the storage unit 340.

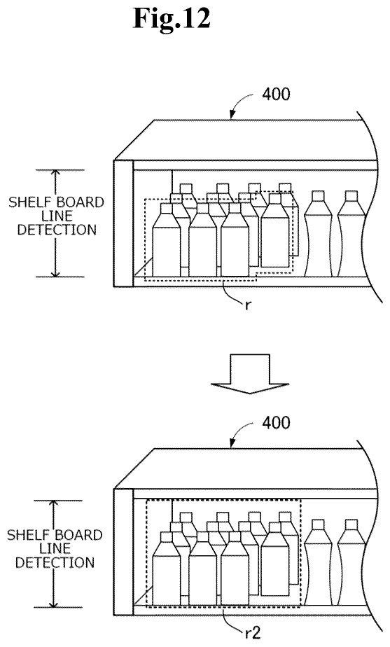

FIG. 12 illustrates an example of a target frame setting process. Referring to FIG. 12, the target frame setting unit 355 detects a shelf board line which is a region where a shelf board constituting the product rack 400 exists, based on the image data on which clustering has been performed. Then, the target frame setting unit 355 sets the target frame r based on the result of clustering and the detected shelf board line. That is to say, the target frame setting unit 355 identifies ae range where products are possibly present based on the detected shelf board line, and sets the target frame r in such a manner as to include the identified range. For example, the target frame setting unit 355 creates a target frame r that encompasses the respective rectangles classified in the same cluster, and then expands the top and bottom of the target frame r to align with the detected shelf board line. As a result, for example, as indicated by a target frame r2 illustrated in FIG. 12, the target frame setting unit 355 can set the target frame r in such a manner as to more properly include the products that are subjected to stockout detection.

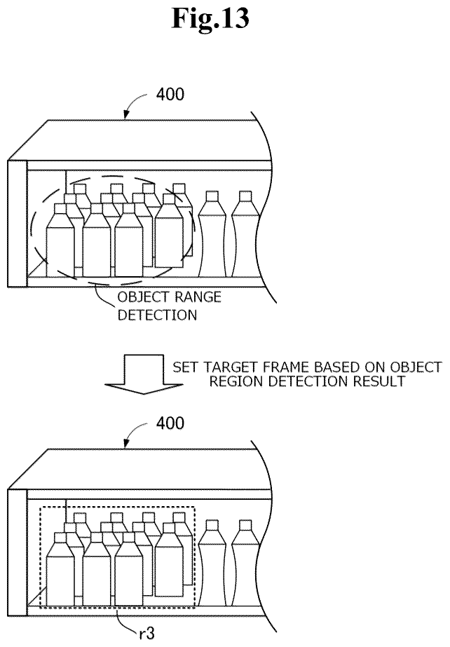

Further, FIG. 13 illustrates another example of the target frame setting process. For instance, as shown in FIG. 13, instead of detecting a shelf board line, the target frame setting unit 355 may use the result of object detection using any object detector to identify a range where products are possibly present. For example, the detection apparatus 300 identifies the range where some object exists by using any object detector or the like. Then, the target frame setting unit 355 sets the target frame r in such a manner as to include the identified range. As a result, the target frame setting unit 355 can set the target frame r in such a manner as to more properly include the product subjected to stockout detection, as exemplified by a target frame r3 in FIG. 13.

The target frame setting unit 355 may use any of the abovementioned methods to set the target frame r, or may combine the abovementioned methods to set the target frame r. The target frame setting unit 355 may also use methods other than those exemplified above to set the target frame r based on the result of clustering and the image data.

The object region detecting unit 356 detects an object region based on the image data for detection stored in the storage unit 340 as the comparison image information 342. For example, the object region detecting unit 356 can detect an object region based on image data by performing processing using the result of learning such as semantic segmentation to detect an object region on a pixel-by-pixel basis. The object region detecting unit 356 may detect an object region by a method different from that of the object detecting unit 352, or it may detect an object region by a the same method as that of the object detecting unit 352.

The ratio calculating unit 357 calculates the ratio occupied by the object region for each target frame r based on the target frame information 343 and the result of detection by the object region detecting unit 356. Moreover, the ratio calculating unit 357 functions as a detecting unit that performs stockout detection for each target frame r based on the result of calculation of the ratio. For example, the ratio calculating unit 357 determines that a stockout has occurred in the target frame r where the ratio has been calculated when the calculated ratio falls below a predetermined first threshold value. The ratio calculating unit 357 may determine that the quantity of product has increased when the calculated ratio exceeds a predetermined second threshold value. The first threshold value and the second threshold value may be determined optionally. Moreover, the first threshold value and the second threshold value may be the same value for every target frame r, or they may be different for each target frame r.

The output unit 358 performs output according to the result of determination by the ratio calculating unit 357. For example, the output unit 358 displays information according to the determination result on the screen display unit 320. The output unit 358 may transmit information according to the determination result to an external device via the communication I/F unit 330.

For example, in a case where the ratio calculating unit 357 determines that a stockout has occurred, the output unit 358 outputs the occurrence of stockout. In this case, as illustrated in FIG. 14, the output unit 358 can cut out a target frame r portion where a stockout has been determined to have occurred of the image data included in the reference image information 341, and output the cut-out image portion. By performing such output, the output unit 358 can present the details of stockout products to the output destination without specifying the product names or other details within the target frame r. Moreover, the output unit 358 can perform the same processing when it determines an increase in quantity of products. When an increase in quantity of products is determined, the output unit 358 may notify the result cut out from the image data for detection.

This concludes the example of the configuration of the detection apparatus 300. Next, with reference to FIGS. 15 and 16, an example of the operation of the detection apparatus 300 will be described.

FIG. 15 is a flowchart showing an example of the operation of the detection apparatus 300 at the time of target frame setting. Referring to FIG. 15, the image data acquiring unit 351 acquires image data for target frame setting from the image pickup device 200 (step S101).

The object detecting unit 352 performs an object detection process to detect a product portion in image data based on the image data for target frame setting (step S102). The object detecting unit 352 may perform object detection in image data by inputting the image data for target frame setting into a previously trained model such as a general-purpose product detector. The object detecting unit 352 may perform object detection using other known methods. For example, the object detecting unit 352 can obtain a rectangle containing the detected product by performing the object detection process.

The feature value extracting unit 353 extracts a feature value of a product that is an object by extracting a feature value from the rectangle detected by the object detecting unit 352 (step S103). For example, the feature value extracting unit 353 can extract a feature value corresponding to the appearance of the product, such as the outer shape, color and pattern of the product, as the feature value of the product detected by the object detecting unit 352.

The clustering unit 354 performs clustering based on the feature value extracted by the feature value extracting unit 353 and the position of the product from which the feature value has been extracted (step S104). That is to say, the clustering unit 354 classifies the products in the image data into a plurality of clusters based on the feature values extracted by the feature value extracting unit 353, the positional relation of the products, and so forth. Generally, in the product rack 400, products of the same type are placed on the same shelf. Therefore, the clustering unit 354 may perform clustering for each shelf of the product rack 400.

The target frame setting unit 355 sets a target frame r in such a manner as to include a stockout detection target based on the result of clustering by the clustering unit 354 and the image data (step S105). For example, the target frame setting unit 355 sets a target frame r in such a manner as to include a stockout detection target based on the result of clustering, and the results of shelf board line detection and detection of a range where an object such as a product is present based on the image data. Moreover, the target frame setting unit 355 can store the set result as the target frame information 343 into the storage unit 340.

This concludes the example of the operation of the detection apparatus 300 at the time of target frame setting. Next, with reference to FIG. 16, an example of the operation of the detection apparatus 300 at the time of stockout detection will be described.

FIG. 16 is a flowchart showing an example of the operation of the detection apparatus 300 at the time of stockout detection. Referring to FIG. 16, the image data acquiring unit 351 obtains image data for detection from the image pickup device 200 (step S201).

The object region detecting unit 356 detects an object region based on the image data for detection stored in the storage unit 340 as the comparison image information 342 (step S202). For example, the object region detecting unit 356 may detect an object region based on the image data by performing processing using the result of learning such as semantic segmentation to detect an object region on a pixel-by-pixel basis.

The ratio calculating unit 357 calculates a ratio occupied by the object region for each target frame r based on the target frame information 343 and the result of detection by the object region detecting unit 356 (step S203). Moreover, the ratio calculating unit 357 performs stockout detection for each target frame r based on the result of calculation of the ratio (step S204).

In a case where there exists a target frame r where the calculated ratio falls below a predetermined first threshold value (step S204, Yes), the ratio calculating unit 357 detects that a stockout has occurred. In response to this, the output unit 358 outputs a notification that a stockout has occurred (step S205). In this case, the output unit 358 may cut out the target frame r portion where a stockout has been determined to have occurred of the image data included in the reference image information 341, and output the cut-out image portion. On the other hand, in a case where there is no target frame r where the calculated ratio falls below the predetermined first threshold value (step S204, No), the detection apparatus 300 ends the process.

This concludes the example of the operation of the detection apparatus 300 at the time of stockout detection.

Thus, the detection apparatus 300 includes the clustering unit 354 and the target frame setting unit 355. According to such a configuration, the target frame setting unit 355 can set a target frame r in such a manner as to include a stockout detection target based on the result of clustering by the clustering unit 354 and image data. In other words, according to the above configuration, it is possible to accurately set an appropriate range for product monitoring. As a result, it becomes possible to perform stockout detection more appropriately.

The configuration of the detection apparatus 300 is not limited to the case illustrated in the present disclosure. For instance, FIG. 17 shows another example of the configuration of the detection apparatus 300. Referring to FIG. 17, the arithmetic processing unit 350 of the detection apparatus 300 can enable an execution possibility determining unit 359 in addition to the configuration illustrated in FIG. 4 by loading and executing the program 344 stored in the storage unit 340.

The execution possibility determining unit 359 determines whether or not to perform setting of a target frame r based on the image data for target frame setting. For example, the execution possibility determining unit 359 may determine to set a target frame r in accordance with whether or not a certain condition determined in advance is satisfied.

For example, the execution possibility determining unit 359 can determine to perform setting of a target frame r in response to acceptance of input of stock replenishment completion from an external device or the like. Based on this determination, it is possible to start the process of setting the target frame r by the object detecting unit 352, the feature value extracting unit 353, the clustering unit 354, and the target frame setting unit 355. Further, the execution possibility determining unit 359 may instruct the image pickup device 200 to acquire the image data for target frame setting in response to acceptance of input of stock replenishment completion from an external device or the like.

The execution possibility determining unit 359 may be configured to make determinations based on conditions other than those exemplified above. For example, the execution possibility determining unit 359 may determine whether to perform setting of a target frame r in accordance with the result of image analysis on image data acquired from the image pickup device 200, such as image data for target frame setting. For example, the execution possibility determining unit 359 may determine to set a target frame r in response to detecting the completion of product replenishment as a result of image analysis. The image analysis may be enabled using any method, such as using a pre-trained model.

In addition, the execution possibility determining unit 359 may determine to perform the target frame setting process following the processing by the feature value extracting unit 353, on the condition that the object detecting unit 352 has detected a predetermined number of or more products. In this case, the execution possibility determining unit 359 may determine whether or not to perform the target frame setting process for each shelf that constitutes the product rack 400.

### Second Example Embodiment

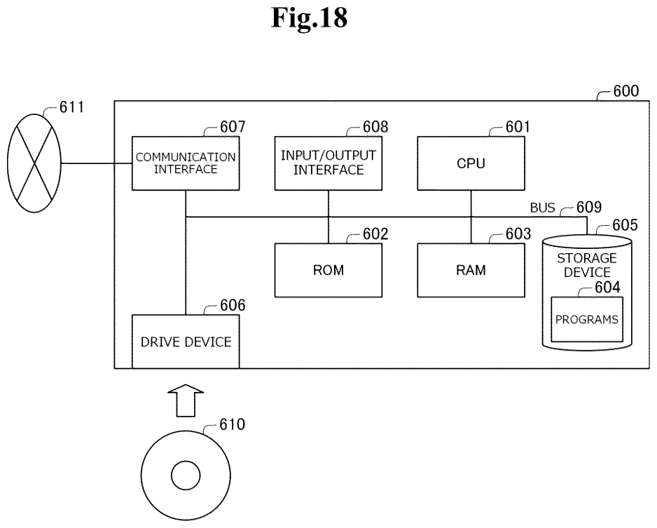

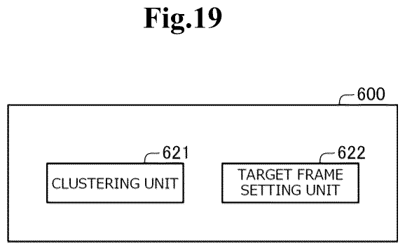

Next, a second example embodiment of the present disclosure will be described with reference to FIGS. 18 and 19. FIG. 18 is a diagram showing an example of a hardware configuration of a setting apparatus 600. FIG. 19 is a block diagram showing an example of a configuration of the setting apparatus 600.

In the second example embodiment of the present disclosure, the setting apparatus 600 that sets a target frame for stockout detection will be described. FIG. 18 shows an example of the hardware configuration of the setting apparatus 600. Referring to FIG. 18, the setting apparatus 600 has, as an example, the following hardware configuration including:
a CPU (Central Processing Unit) 601 (arithmetic logic unit);
a ROM (Read Only Memory) 602 (memory unit);
a RAM (Random Access Memory) 603 (memory unit);
programs 604 loaded into the RAM 603;
a storage device 605 storing the programs 604;
a drive device 606 that reads from and writes to a recording medium 610 outside the information processing apparatus;
a communication interface 607 that connects to a communication network 611 outside the information processing apparatus;
an input/output interface 608 that performs input/output of data; and
a bus 609 connecting the components.

Further, the setting apparatus 600 can enable functions as a clustering unit 621 and a setting unit 622 shown in FIG. 19 by acquisition and execution of the programs 604 by the clustering unit 601. The programs 604 are, for example, stored in advance in the storage device 605 or the ROM 602, and are loaded into the RAM 603 or the like and executed by the CPU 601 as necessary. Additionally, the programs 604 may be provided to the CPU 601 via the communication network 611, or it may be previously stored in the recording medium 610, and read out and provided by the drive device 606 to the CPU 601.

FIG. 18 shows an example of the hardware configuration of the setting apparatus 600. The hardware configuration of the setting apparatus 600 is not limited to the abovementioned case. For example, the setting apparatus 600 may be configured with only part of the abovementioned configuration, such as not having the drive device 606. Also, the CPU 601 may be a GPU or the like as illustrated in the first example embodiment.

The clustering unit 621 performs clustering, which is a process of classifying objects, based on a feature value of an object extracted from image data including a plurality of objects in a subject and the position of the object.

The setting unit 622 sets a target frame indicating a range for stockout detection based on the result of clustering by the clustering unit 621 and the image data.

Thus, the setting apparatus 600 includes the clustering unit 621 and the setting unit 622. With this configuration, the setting unit 622 can set a target frame indicating a range for stockout detection based on the result of clustering by the clustering unit 621 and the image data. In other words, according to the above configuration, it is possible to accurately set an appropriate range for product monitoring. As a result, it is possible to perform stockout detection more appropriately.

The setting apparatus 600 described above can be enabled by incorporating a predetermined program into the information processing apparatus such as the setting apparatus 600. Specifically, a program, which is another aspect of the present invention, is a program for enabling a process in an information processing apparatus such as the setting apparatus 600, wherein the process includes performing clustering, which is a process of classifying objects based on feature values of objects extracted from image data containing multiple objects in a subject and the positions of the objects, and setting a target frame indicating a range for detecting missing products based on the clustering results and the image data.

Furthermore, a setting method executed by an information processing apparatus such as the aforementioned setting apparatus 600 is a method that performs clustering, which is a process of classifying objects based on the feature quantities extracted from image data containing multiple objects in a subject, and the positions of the objects, and then sets a target frame indicating the range for detecting missing items based on the clustering results and the image data.

Even if it is an invention of a program having the aforementioned configuration, a computer-readable recording medium on which the program is recorded, or a setting method, it can achieve the purpose of the above-mentioned disclosure in order to produce effects similar to those of the setting apparatus 600 described above.

### SUPPLEMENTARY NOTES

The whole or part of the above example embodiments can be described as the following supplementary notes. Below, the overview of a setting apparatus and so forth according to the present invention will be described. However, the present invention is not limited to the following configurations.

### Supplementary Note 1

A setting apparatus comprising:
a clustering unit configured to perform clustering, which is a process of classifying a plurality of objects, based on feature values of the objects extracted from image data including the objects in a subject and positions of the objects; and
a setting unit configured to set a target frame indicating a range to perform stockout detection, based on a result of the clustering by the clustering unit and the image data.

### Supplementary Note 2

The setting apparatus according to supplementary note 1, wherein
the setting unit is configured to set the target frame in such a manner as to include a range of the object determined based on the image data.

### Supplementary Note 3

The setting apparatus according to supplementary note 1 or 2, wherein
the setting unit is configured to detect a shelf board line, which is a region in which a shelf board configuring a rack for arrangement of the objects is present, based on the image data, and set the target frame based on the result of the clustering by the clustering unit and the detected shelf board line.

### Supplementary Note 4

The setting apparatus according to any one of supplementary notes 1 to 3, wherein
the setting unit is configured to set the target frame based on the result of the clustering by the clustering unit and a range in which the object is present determined in accordance with a result of object detection on the image data.

### Supplementary Note 5

The setting apparatus according to any one of supplementary notes 1 to 4, wherein
the clustering unit is configured to perform the clustering for each shelf of a rack for arrangement of the objects.

### Supplementary Note 6

The setting apparatus according to any one of supplementary notes 1 to 5, wherein
the clustering unit is configured to, in a case where the objects are determined to belong to a same cluster based on a positional relation of the objects, classify the determined objects into a cluster according to a result of the determination.

### Supplementary Note 7

The setting apparatus according to any one of supplementary notes 1 to 6, wherein
the clustering unit is configured to perform the clustering by comparing the feature values of the objects after rearranging the objects to a filled-in state.

### Supplementary Note 8

The setting apparatus according to any one of supplementary notes 1 to 7, wherein
the clustering unit is configured to acquire a feature value of a part corresponding to a gap in arrangement of the objects from a past image, and perform the clustering based on the feature values of the objects extracted from the image data and the feature value acquired from the past image.

### Supplementary Note 9

The setting apparatus according to any one of supplementary notes 1 to 8, wherein
the clustering unit is configured to perform the classification based on a result of detecting a shelf tag installed on a rack for arrangement of the objects.

### Supplementary Note 10

The setting apparatus according to supplementary note 9, wherein
the clustering unit is configured to control a number of clusters to classify the objects in accordance with a number of the detected shelf tag.

### Supplementary Note 11

The setting apparatus according to any one of supplementary notes 1 to 10, wherein
the clustering unit is configured to determine a threshold value based on a degree of similarity calculated based on the feature values of the objects adjacent to each other and a degree of similarity calculated based on the feature values of the objects not adjacent to each other in the image data, and perform the clustering using the determined threshold value.

### Supplementary Note 12

The setting apparatus according to any one of supplementary notes 1 to 11, comprising
a determining unit configured to determine whether or not to set the target frame, wherein
the clustering unit is configured to perform the clustering in accordance with a result of the determination by the determining unit.

### Supplementary Note 13

The setting apparatus according to any one of supplementary notes 1 to 12, comprising:
a detecting unit configured to perform the stockout detection using the target frame set by the setting unit; and
an output unit corresponding to a result of the detection by the detecting unit, wherein
the output unit is configured to output an image corresponding to the target frame where stockout is detected in accordance with the result of the stockout detection by the detecting unit.

### Supplementary Note 14

A setting method by an information processing apparatus, the method comprising:
performing clustering, which is a process of classifying a plurality of objects, based on feature values of the objects extracted from image data including the objects in a subject and positions of the objects; and
setting a target frame indicating a range to perform stockout detection, based on a result of the clustering and the image data.

### Supplementary Note 15

A non-transitory computer-readable recording medium where a program is recorded, the program comprising instructions for causing an information processing apparatus to execute processes to:
perform clustering, which is a process of classifying a plurality of objects, based on feature values of the objects extracted from image data including the objects in a subject and positions of the objects; and
set a target frame indicating a range to perform stockout detection, based on a result of the clustering and the image data.

The program described in the above example embodiments and supplementary notes may be stored in a storage device, or the program may be recorded on a computer-readable recording medium. For example, the recording medium is a portable medium such as flexible disk, optical disk, magneto-optical disk, and semiconductor memory.

Although the present invention has been described above with reference to the above example embodiments, the present invention is not limited to the example embodiments described above. The configuration and details of the present invention can be changed in various manners that can be understood by those skilled in the art within the scope of the present invention.

### REFERENCE SIGNS LIST

100 detection system
200 image pickup device
300 detection apparatus
310 operation input unit
320 screen display unit
330 communication I/F unit
340 storage unit
341 reference image information
342 comparison image information
343 target frame information
344 program
350 arithmetic processing unit
351 image data acquiring unit
352 object detecting unit
353 feature value extracting unit
354 clustering unit
355 target frame setting unit
356 object region detecting unit
357 ratio calculating unit
358 output unit
359 execution possibility determining unit
400 product rack
511 product
512 product
513 product
514 product
515 product
516 product
517 product
518 product
521 product
522 product
523 product
524 product
525 product
526 product
527 product
531 product
532 product
533 product
534 product
535 product
536 product
537 product
538 product
541 product
542 product
543 product
544 product
545 product
546 product
547 product
548 product
600 setting apparatus
601 CPU
602 ROM
603 RAM
604 programs
605 storage device
606 drive device
607 communication interface
608 input/output interface
609 bus
610 recording medium
611 communication network
621 clustering unit
622 setting unit

What is claimed is:

1. A setting apparatus comprising:
at least one memory storing processing instructions; and
at least one processor configured to execute the processing instructions, wherein the processor is configured to execute the processing instructions to:
performing clustering, which is a process of classifying a plurality of objects, based on feature values of the objects extracted from image data including the objects in a subject and positions of the objects; and
set a target frame indicating a range to perform stockout detection, based on a result of the clustering and the image data.

2. The setting apparatus according to claim 1, wherein the processor is configured to execute the processing instructions to
set the target frame in such a manner as to include a range of the object determined based on the image data.

3. The setting apparatus according to claim 1, wherein the processor is configured to execute the processing instructions to
detect a shelf board line, which is a region in which a shelf board configuring a rack for arrangement of the objects is present, based on the image data, and set the target frame based on the result of the clustering and the detected shelf board line.

4. The setting apparatus according to claim 1, wherein the processor is configured to execute the processing instructions to
set the target frame based on the result of the clustering and a range in which the object is present determined in accordance with a result of object detection on the image data.

5. The setting apparatus according to claim 1, wherein the processor is configured to execute the processing instructions to
perform the clustering for each shelf of a rack for arrangement of the objects.

6. The setting apparatus according to claim 1, wherein the processor is configured to execute the processing instructions to
in a case where the objects are determined to belong to a same cluster based on a positional relation of the objects, classify the determined objects into a cluster according to a result of the determination.

7. The setting apparatus according to claim 1, wherein the processor is configured to execute the processing instructions to
perform the clustering by comparing the feature values of the objects after rearranging the objects to a filled-in state.

8. The setting apparatus according to claim 1, wherein the processor is configured to execute the processing instructions to
acquire a feature value of a part corresponding to a gap in arrangement of the objects from a past image, and perform the clustering based on the feature values of the objects extracted from the image data and the feature value acquired from the past image.

9. The setting apparatus according to claim 1, wherein the processor is configured to execute the processing instructions to
perform the classification based on a result of detecting a shelf tag installed on a rack for arrangement of the objects.

10. The setting apparatus according to claim 9, wherein the processor is configured to execute the processing instructions to
control a number of clusters to classify the objects in accordance with a number of the detected shelf tag.

11. The setting apparatus according to claim 1, wherein the processor is configured to execute the processing instructions to
determine a threshold value based on a degree of similarity calculated based on the feature values of the objects adjacent to each other and a degree of similarity calculated based on the feature values of the objects not adjacent to each other in the image data, and perform the clustering using the determined threshold value.

12. The setting apparatus according to claim 1, wherein the processor is configured to execute the processing instructions to:
determine whether or not to set the target frame; and
perform the clustering in accordance with a result of the determination.

13. The setting apparatus according to claim 1, wherein the processor is configured to execute the processing instructions to:
perform the stockout detection using the set target frame; and
perform output corresponding to a result of the detection; and
output an image corresponding to the target frame where stockout is detected in accordance with the result of the stockout detection.

14. A setting method by an information processing apparatus, the method comprising:
performing clustering, which is a process of classifying a plurality of objects, based on feature values of the objects extracted from image data including the objects in a subject and positions of the objects; and
setting a target frame indicating a range to perform stockout detection, based on a result of the clustering and the image data.

15. A non-transitory computer-readable recording medium where a program is recorded, the program comprising instructions for causing an information processing apparatus to execute processes to:
perform clustering, which is a process of classifying a plurality of objects, based on feature values of the objects extracted from image data including the objects in a subject and positions of the objects; and
set a target frame indicating a range to perform stockout detection, based on a result of the clustering and the image data.
